(19) United States
(12) Patent Application Publication
(10) Pub. No.: US 2016/0049838 A1
(43) Pub. Date: Feb. 18, 2016

(54) SYNCHRONOUS MACHINE

(71) Applicant: FEAAM GMBH, Neubiberg (DE)

(72) Inventor: Gurakuq DAJAKU, Neubiberg (DE)

(21) Appl. No.: 14/778,999

(22) PCT Filed: Mar. 20, 2014
(86) PCT No.: PCT/EP2014/055613

§ 371 Date: Sep. 21, 2015

(30) Foreign Application Priority Data
Mar. 21, 2013 (DE) 10 2013 102 900.0

(51) Int. Cl. H02K 3/28; H02K 1/24; H02K 11/04; H02K 19/12

(52) U.S. Cl. CPC H02K 3/28; H02K 19/12; H02K 1/24; H02K 11/04

(57) ABSTRACT

A synchronous machine with a stator (1) and a rotor (2), which is situated so it can move relative to the stator, is indicated. The stator (1) comprises at least one concentrated winding (A, B, C), which is located in slots of the stator (1). The rotor (2) has a first winding system, which is set up as the excitation winding (6), and at least one second winding system, which is set up as the field winding (3), and a rectifier (4), which is connected between these two concentrated winding systems. The first and second winding systems comprise a concentrated winding.

The invention under consideration concerns a synchronous machine with a stator and a rotor.

Synchronous machines normally comprise a stationary stator and a rotor which can move relative to the stator. The stator of a synchronous machine is usually provided to hold an electrical winding, which can be multiphase. For example, in a three-phase alternating current machine, the windings correlated with the three electrical phases are electrically phase-shifted by 120°, relative to one another.

In the rotor, permanent magnets are frequently used. Alternatively, electromagnets are possible, wherein here a direct current, which flows through coils wound around rotor teeth, is used. The direct current can be transferred into the rotor via brushes or via exciter windings and a rotating rectifier.

A synchronous machine means that the rotor and the rotating field of the stator rotate at the same speed.

An electromagnetic torque on the shaft of the stator is created by the interaction of the magnetic fields of the stator and the rotor.

For some time, synchronous machines with permanent magnets, so-called PM machines, have been on the rise, because they interconnect a high energy density, a compact design, a high efficiency, and a wide rotational speed range. In the last few years, however, the prices for permanent magnet material have gone up considerably. Moreover, there are certain application cases, such as the short circuit case, which limit the use of PM machines in some applications.

Therefore, the current-energized synchronous alternating current machines are an interesting alternative for the future.

A direct current is hereby used, in order to produce the stationary magnetic field of the stator. As already indicated above, the direct current needed for the creation of the field is first transferred from the stator to the rotor. For this, additional windings are usually used in the stator. The additional energy is transferred via the air gap into exciter windings of the rotor and there rectified with the aid of the rectifier and supplied to the field winding(s) which produce the stationary magnetic field of the rotor with the direct current thus obtained. This principle is often designated as self-excitation.

Such self-excited machines are used, for example, in wind generators.

The auxiliary winding in the stator, which the magnetic field makes available for the transfer of the energy into the rotor, is mostly called the exciter field winding and is frequently operated with direct current.

For this, a rectifier is normally also required in the stator. Beyond that, the additional winding is needed in the stator, which is also called the stator auxiliary winding. This leads to the larger stator volume. The auxiliary winding must be sufficiently insulated with respect to the other windings.

Another disadvantage of the described machine type is that windings with q>1, overlapping one another and frequently distributed in the stator, are used, wherein q is the number of the coils per phase and per pole. For the exciter winding in the rotor, a large number of coils per winding are required. A higher engine inertia leads, moreover, to impaired dynamic characteristics of the electric machine. In some known machines, additional slots are needed in the rotor, in order to be able to introduce the field winding and the exciter windings of the rotor into the same rotor core. In this way, the result is also a complex production process.

In the analysis of the harmonics in the air gap, it is evident that the auxiliary winding in the stator produces higher harmonics in the air gap, which form a stationary field. The higher harmonics which are produced by the multiphase main winding of the stator rotate in time, but at different speeds. Thus, there are different harmonics which appear at different rotational speeds, which leads to a fluctuation of the induced voltage in the rotor exciter windings. This leads to a negative influencing of the operating characteristics of the synchronous machine.

The goal of the invention under consideration, therefore, is to make available a synchronous machine with improved characteristics.

In accordance with the invention, the goal is attained by a synchronous machine with the features of the independent patent claim. Developments and refinements are indicated in the dependent patent claims.

In one embodiment, a synchronous machine comprises a stator and a rotor which is situated so it can move relative to the stator. The stator comprises at least one concentrated winding, which is situated in the slots of the stator. An auxiliary winding is not provided separately in the stator. In the rotor, a first winding system is provided, which is set up as the exciter winding and can absorb the energy from the field in the air gap. Furthermore, at least one second winding system is provided, which is set up as the field winding, that is, which is able to produce a stationary magnetic field. Moreover, a rectifier is provided in the rotor, which is connected between the first and the second concentrated winding system, in order to make available the direct current for the production of the magnetic field of the rotor. The first and second winding systems of the rotor comprise a concentric winding.

Since the stator does not have an auxiliary winding, the rectifier bridge for this is also omitted in the stator. With the at least one concentrated winding of the stator, which is normally designed multiphase, both the work harmonic for the synchronous machine is produced as well as, purposefully, a higher harmonic, which serves to supply the rotor via its excitation winding.

Thus, the proposed principle permits a simplified structure of a synchronous machine, which can dispense with the permanent magnets of the rotor.

In one refinement, the at least one concentrated winding of the stator is designed as a multiphase, especially three-phase, concentrated winding. A concentrated winding can be produced at particularly low cost, in comparison to a distributed winding which is made via several teeth and overlapping in phases. In addition, the multiphase design permits a harmonic field distribution and, moreover, a simple connection of the machine to an electrical multiphase system.

Alternatively or additionally, the first winding system of the rotor, that is, the exciter winding, is also designed multiphase as a concentrated winding.

As the work harmonic, the basic harmonic of the magnetomotive force is not used, but rather a higher harmonic of the magnetomotive force which is produced by the stator winding. For example, in a machine with twelve slots in the stator and ten poles in the rotor and a teeth-concentrated winding in the stator, the fifth harmonic can be used as the work harmonic.

Additionally preferred, a higher harmonic of the electromotive force of the stator, different from the work harmonic, is used as the exciter harmonic for the supply of the exciter winding. In the example mentioned for a concentrated winding with twelve slots and ten poles, the seventh harmonic can be advantageously used as the exciter harmonic.

One can clearly see in this example that a higher harmonic of a machine with a concentrated winding in the stator, which is, in fact, undesired, can be advantageously and deliberately used for the purpose, in order to provide the exciter winding in the rotor with electrical energy.

Advantageously, the at least one concentrated winding of the stator produces both the work harmonic as well as the exciter harmonic.

In one embodiment, the field winding in the rotor comprises several coils which are wound around a tooth of the rotor and are connected in series with one another. The serial connection of the field winding is thereby designed in such a way that along the circumference of the rotor, magnetic north poles and magnetic south poles arise with the flow of direct current through the serial connection.

The exciter winding preferably has a high winding factor.

The exciter winding and the field winding are preferably wound around the same teeth of the rotor.

In one refinement, the field winding and the exciter winding have different coil widths and are, insofar, adapted to the different conditions in the air gap with regard to the individually used harmonics. For example, the field winding can have a larger coil width than the exciter winding, since the field winding is adapted to the fifth harmonic and the exciter winding, to the seventh harmonic. The different coil width can, for example, be implemented in a salient pole rotor in that the field winding is wound around the tooth neck of the salient pole, whereas the exciter winding is in the tooth crest with a smaller coil width.

Alternatively or additionally, permanent magnets can be introduced in the rotor, for example, in the leg poles.

Since the proposed synchronous machine has a self-excitation of the rotor via the air gap field of the machine, slip rings and brushes for the galvanic direct current transfer are omitted. In addition, an auxiliary winding and a rectifier in the stator are not needed.

Preferably, the rotor windings—that is, the first and the second winding systems—are made exclusively as concentrated tooth coil windings; that is, all coils of the windings are wound around exactly one tooth.

Preferably, separate tooth coil windings are provided for the excitation winding and the field winding.

The rectification is preferably implemented as a full bridge rectifier circuit.

Preferably, two coils, or multiples thereof, in which the current is induced in the rotor, are connected in series before they are connected to the full bridge rectifier. The excitation winding accordingly always comprises at least two coils in the serial connection.

The invention is explained in more detail, below, on several embodiment examples with the aid of drawings.

The figures show the following:

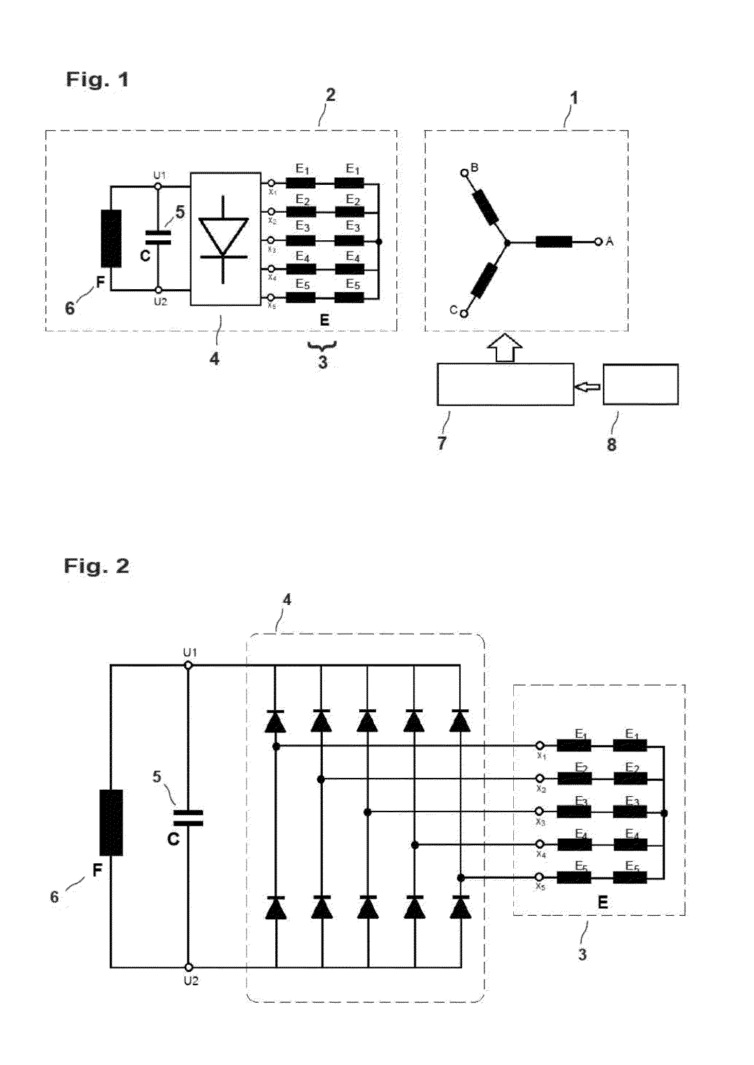

FIG. 1 an embodiment example of a block diagram of a synchronous machine according to the proposed principle;

FIG. 2 the exemplary implementation of a rotor according to the proposed principle, with the aid of a block diagram;

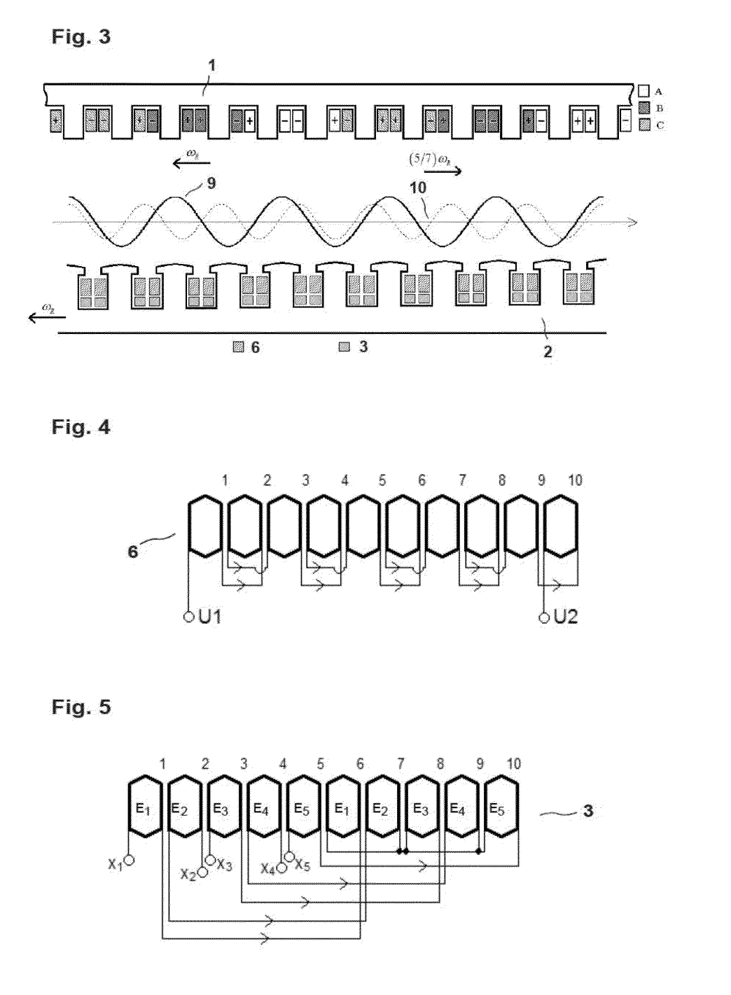

FIG. 3 the self-excitation concept according to the proposed principle, on the example of a machine with twelve slots and ten poles;

FIG. 4 an embodiment example of the field winding of the rotor;

FIG. 5 an embodiment example of the excitation winding of the rotor;

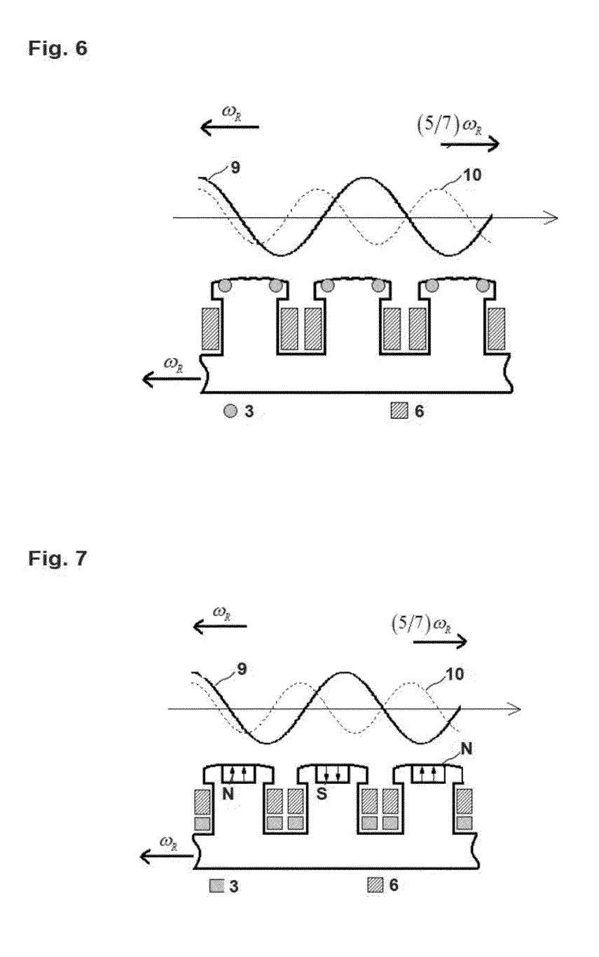

FIG. 6 an embodiment example of a refinement of the winding system of the rotor;

FIG. 7 another refinement of the winding systems of the rotor on an example,

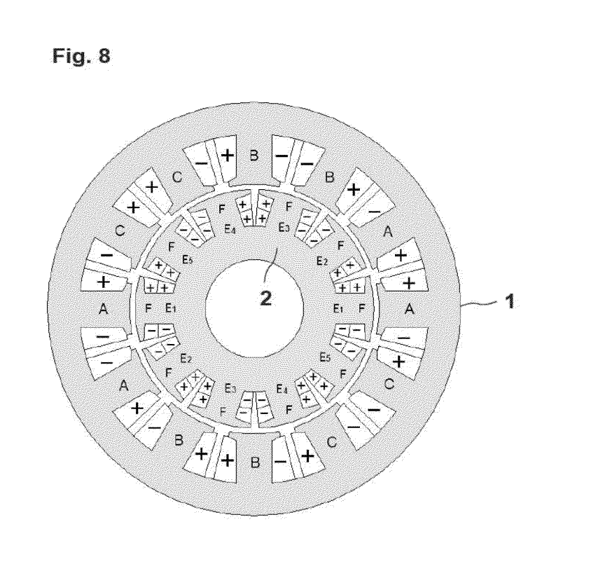

FIG. 8 an embodiment example of a synchronous machine with a stator and rotor in a cross-sectional representation;

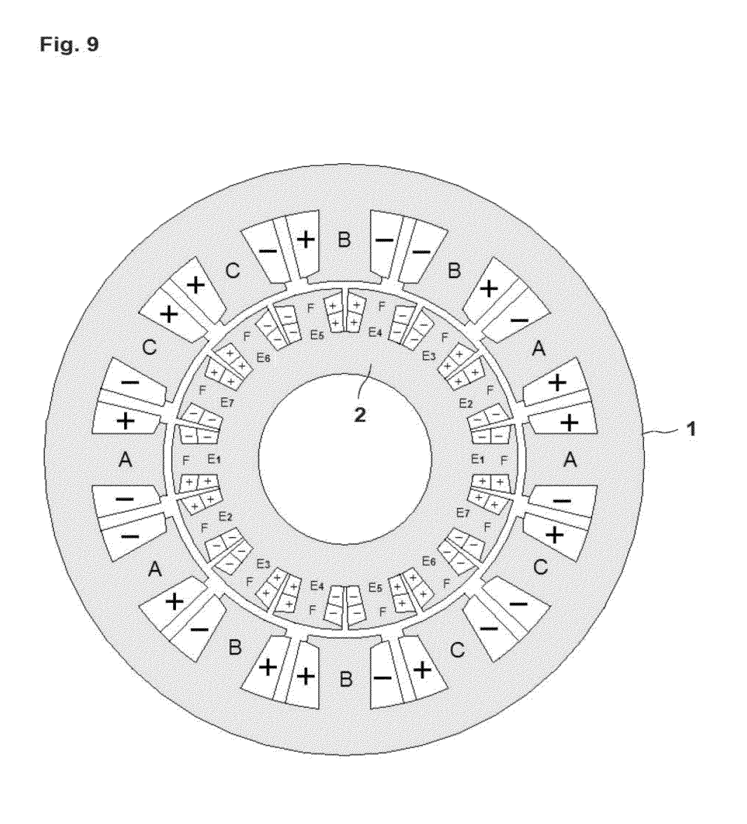

FIG. 9 another embodiment example of a synchronous machine with a stator and rotor in a cross-sectional representation;

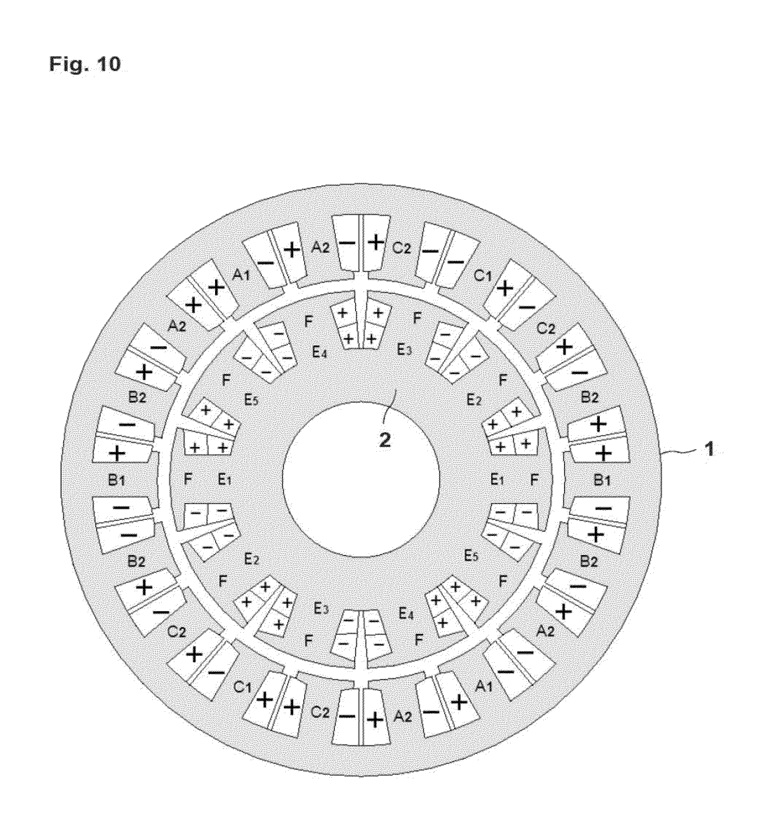

FIG. 10 another embodiment example of a synchronous machine with a stator and rotor in a cross-sectional representation; and

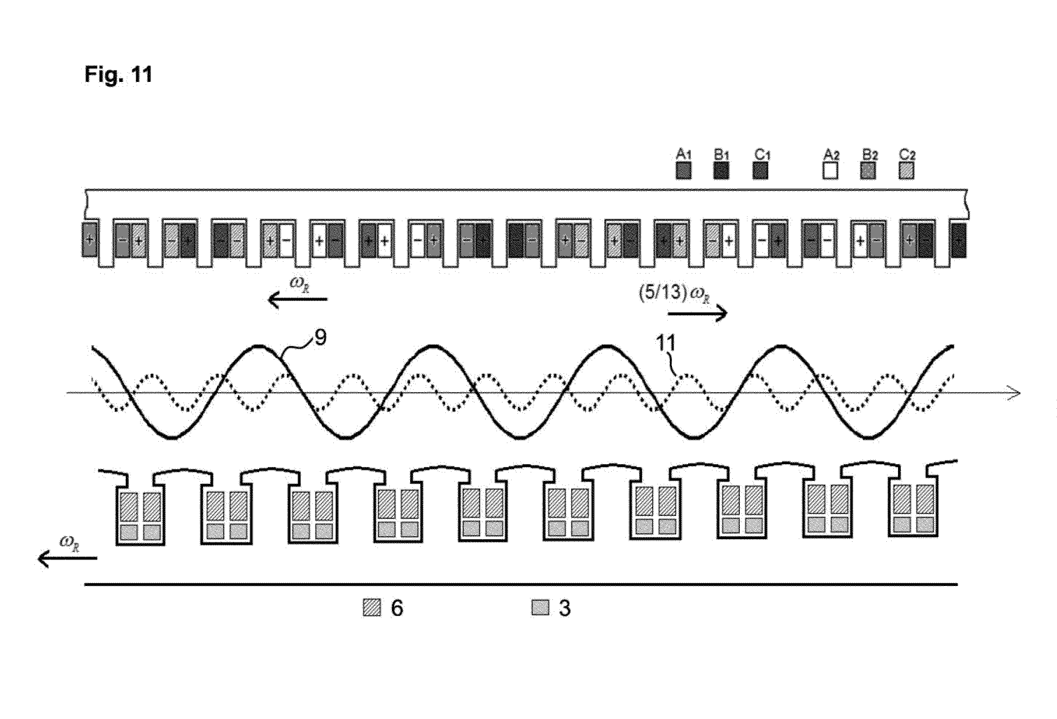

FIG. 11 the self-excitation concept according to the proposed principle on the example of a machine with 18 slots and ten poles.

FIG. 1 shows a block diagram of a synchronous machine according to the proposed principle, with the aid of an embodiment example. The synchronous machine comprises a stator 1 and a rotor 2. The stator comprises an electrical winding which is designed three-phase here and is introduced into slots of the stator. The three electrical strands of the winding, which are electrically phase-shifted by 120°, relative to one another, are designated with A for the first phase, B for the second phase, and C for the third phase.

Rotor 2 is situated relative to this. The rotor comprises a first winding system 3, which is designed as an excitation winding. In the example under consideration, the excitation winding is designed with five strands E1 to E5, which comprise two coils connected in series. The basis in the example is thereby a ten-pole rotor, wherein the exact winding topology of this example will be illustrated later with the aid of FIG. 5.

This excitation winding 3 is connected with a rectifier 4 via five terminals X1 to X5; it is designed here as a full bridge diode rectifier. The diode rectifier makes available a direct current to the outlet terminals U1, U2. The direct voltage is smoothed out with a capacitance 5, which comprises a capacitor C. The capacitor C can also be omitted. A field winding 6 is connected in parallel to it; there is a direct current flow through it, which produces a stationary rotor magnetic field and can thus make permanent magnets in the rotor superfluous.

It is remarkable that the stator 1 does not comprise a rectifier or an auxiliary winding. The energy for the excitation of the rotor 2 is rather created by the traditional excitation winding of the stator. The effect is thereby utilized so that the excitation winding of the stator creates both the work harmonic for the synchronous machine as well as at least one upper harmonic—that is, the harmonic of the magnetomotive force, which is used to supply the excitation winding of the rotor.

In the example of FIG. 1, the stator has twelve slots, into which the three-phase winding is introduced as the tooth-concentrated winding.

An exemplary mode of action will be explained later with the aid of FIG. 3.

A current supply unit 7 is provided to supply the stator winding; it prepares a three-phase supply signal and is controlled by a control unit 8. The machine can be operated with a motor or a generator.

FIG. 2 shows an embodiment example of the rectifier 4 of the rotor, which is designed here as a diode bridge rectifier. The five terminals X1 to X5 of the excitation winding, which the five aforementioned strands of the excitation winding are connected to, whose other ends are combined, in turn, in a star point, are connected to center taps between two diodes connected in series. These serial connections of two diodes arranged in the same direction are connected in parallel to one another and laid on two terminals U1, U2 outwards, in order to make available there the direct current to supply the field winding 6.

As mentioned, the full bridge rectifier is used to convert the magnetic field supplied to the excitation winding into a direct current to supply the field winding. The field winding, in turn, creates the stationary magnetic field of the rotor.

On an embodiment example, FIG. 3 shows, in a flattened depiction, the concentrated stator winding and the two winding systems of the rotor. In between, there are exemplary characteristics harmonics of the magnetic flux in the air gap.

In detail, the stator 1 in this example has twelve slots, into which a three-phase electrical, concentrated winding is introduced. The stator is shown in FIG. 3 in the above half of the image. The three winding strands, which are correlated with the electrical phases, are designated with the three letters A, B, C. A concentrated winding means that a coil is wound around every tooth which is formed between two adjacent slots. The direction of the winding is thereby symbolized by the symbols + and −, in each case to the side of the tooth.

In the lower half of the image of FIG. 3, the rotor 2, also in a flattened representation, is shown. The rotor is designed as a salient pole rotor. This means that the teeth formed between the adjacent slots, in the area of the tooth crests—that is, in a radial direction outwards—are wider than in the tooth neck area. In the lower area of the rotor—that is, on the side facing the rotor axis—is where the coils of the concentrated excitation winding are located. Above that, in the radial direction and facing the stator, is where the coils of the concentrated field winding are located. The excitation winding is marked with reference symbol 3; the field winding, with reference symbol 6.

In the example under consideration, in accordance with FIG. 3, the fifth harmonic of the magnetomotive force is used as the work harmonic. Therefore, the rotor 2 is designed as a salient pole rotor with ten poles—that is, with ten teeth. The field winding of the rotor comprises coils which are wound round the individual teeth of the rotor in such a way that a suitable magnetic field of a ten-pole rotor is created. This is further considered below, in more detail, with the aid of FIG. 4.

The middle of the image of FIG. 3 shows the fifth and the seventh harmonics of the magnetomotive force in the air gap, which is created by the stator winding. The fifth harmonic, which is used as the work harmonic, rotates counterclockwise at the rotor speed. The fifth harmonic is designated with the reference symbol 9 and represented as a solid line. In contrast, another characteristic harmonic in the machine shown is present with twelve slots and ten poles and a concentrated winding, namely, the seventh harmonic of the magnetomotive force in the air gap. The seventh harmonic rotates clockwise, at 5/7 of the rotor speed. Therefore, one can see that the fifth and the seventh harmonics spread with different orientations and have different speeds. The seventh harmonic is depicted with a dotted line in the middle of the image of FIG. 3 and marked with the reference symbol 10.

The excitation winding of the rotor is supplied by the seventh harmonic. The seventh harmonic of the magnetomotive force produced by the stator winding is therefore used to supply the field winding of the rotor with energy.

FIG. 3 also shows that the stator winding and the rotor windings for the proposed, self-excited synchronous machine are simple concentrated windings, which are wound around a tooth.

FIG. 4 shows an embodiment example of a rotor winding, which is introduced as a field winding 6 in FIG. 3. The rotor has ten rotor slots, between which teeth of the rotor are formed, around which the field winding is wound in accordance with the winding scheme shown in FIG. 4. The terminals U1, U2 correspond to those of FIGS. 1 and 2. In order to produce north and south poles alternatingly, the adjacent teeth of the rotor are wound in contrary winding directions. All windings are connected in series and are led out on the terminals U1, U2, in order to be supplied there with the excitation direct current by the rectifier 4.

An excitation winding is placed in the rotor, below the field winding in the example of FIG. 3; it is also implemented as a concentrated winding and is shown on the example in FIG. 5. Once again, ten slots of the rotor are present, between which, all total, ten rotor teeth are formed. The adjacent five teeth shown, in FIG. 5, in the left half of the image, have protruding connection terminals X1 to X5, on which a winding coil E1 to E5 is connected. Five additional teeth with coils E1 to E5 follow; they are connected in series with the five coils E1 to E5 first mentioned, staggered around five teeth, in pairs. The resulting free ends of the five coils on the right are combined on a star point. This produces the interconnection of the excitation winding, as it is shown, by way of example, in FIG. 2.

In the embodiment example described, the winding factors for the fifth and the seventh harmonics of the stator winding or its magnetomotive force are the same and are approximately 0.933. Therefore, the flux density in the air gap from these harmonics is also the same. In this way, in turn, as a result of the relatively high fractions of the seventh harmonic and because of the high winding factors of the rotor winding with regard to the seventh harmonic, only a small winding factor is needed, in order to accept this harmonic and to produce sufficient voltage so as to supply the field winding of the rotor by means of the rotating rectifier bridge. The proposed excitation principle in the rotor due to the planned utilization of a harmonic of a concentrated stator winding, which is in any case present, therefore advantageously leads to the dynamic characteristics of the machine and the rotor construction being practically uninfluenced by the proposed self-excitation principle.

FIG. 6 shows an embodiment example of the two rotor windings, in which the coil width of the field winding 6 is greater than that of the excitation winding 3. The coil width of the excitation winding 3 is the same as the pole distance of the seventh harmonic, as is clear with the aid of the figure. The winding factor of the excitation width, relative to the seventh harmonic, can thus be increased up to 1. In FIG. 6, in turn, the fifth harmonic is depicted as a solid line and referenced with the reference symbol 9, whereas the seventh harmonic is depicted as a dotted line and designated with reference symbol 10. The field winding is designed as in FIG. 3, in the area of the tooth neck of the salient pole rotor, wherein the coils are wound, concentrated, around a tooth. One peculiarity is that the excitation winding is located in the crest area, more precisely on the side of the salient pole rotor facing the stator, as a concentrated coil per tooth.

In alternative embodiments, it is, of course, possible, to vary the coil width of the excitation of the rotor in such a way that the effect—that is, the fraction of the higher harmonic, such as of the 17^{th} and 19^{th} harmonics, is reduced to the excitation winding of the rotor, with regard to the induced voltage.

FIG. 7 shows another refinement of the embodiment of the winding of the rotor, proceeding from FIG. 3, in which, in addition to the excitation winding 3 and the field winding 6, permanent magnets S, N are found, with alternating polarity, in adjacent crests of the teeth of the rotor, on the surface of the rotor tooth, facing the stator. The permanent magnets are designated with N for north pole or S for south pole.

The additional permanent magnets have the effect that the characteristic properties of the machine are improved at low speeds.

FIG. 8 shows a cross-section of an exemplary implementation of the principle described with the aid of the preceding figures, on the example of a synchronous machine with twelve slots in stator 1 and ten poles of the salient pole rotor 2. As explained, the fifth harmonic of the magnetomotive force, which is produced by the concentrated stator winding, is used as the work harmonic for the case under consideration of a ten-pole rotor. The seventh harmonic of the magnetomotive force, which is produced by the concentrated stator winding, is used to induce the magnetomotive force in the excitation windings E1 to E5 of the rotor for the self-excitation of the field winding F of the rotor. The concentrated stator winding and the concentrated windings of the rotor are introduced as described in FIGS. 3 to 5.

In contrast, FIG. 9 shows another embodiment example of the synchronous machine, in which the proposed principle is applied on an embodiment of the stator with twelve slots and the rotor with 14 poles. This embodiment in accordance with FIG. 9 largely corresponds to those of FIG. 8. In particular, the configuration and the concentrated three-phase winding of the stator are unchanged. In the rotor, which, in turn, is designed as a salient pole rotor, there are not ten along the circumference, however, but rather 14 slots and teeth. The dimensioning of the excitation windings E1 to E5 and the field winding F is adapted, in FIG. 9, to the changed conditions. Proceeding from the principle described in FIGS. 4 and 5, these windings are thereby expanded from ten to 14 or five to seven teeth.

FIG. 10 shows another embodiment example of the synchronous machine, in which the proposed principle is applied to an embodiment of the stator with 18 slots and the rotor with 10 poles. This embodiment in accordance with FIG. 10 largely corresponds to those of FIG. 8. In particular, the configuration and the windings of the rotor are unchanged. In the stator, however, there are not ten, but rather 18 slots and teeth along the circumference. The dimensioning of the stator winding is adapted, in FIG. 10, to the changed conditions. Proceeding from the principle described above, this winding of the stator is thereby adapted to a stator with 18 slots.

On an embodiment example, FIG. 11 shows, in a flattened representation, the concentrated stator winding and the two winding systems of the rotor for the example of FIG. 10. In between, exemplary characteristic harmonics of the magnetic flux in the air gap are shown.

In detail, the stator 1 shows 18 slots in this example, into which a three-phase electrical, concentrated winding is introduced. The stator is shown in the upper half of the image in FIG. 11. The three winding strands, which the electrical phases are correlated to, are designated with the three letters A, B, C. A concentrated winding means that a coil is wound around each tooth which is formed between two adjacent slots. The winding direction is thereby symbolized by the symbols + and −, each to the side of the tooth.

In the lower half of the image of FIG. 11, the rotor 2, likewise in a flattened representation, is shown. The rotor is designed as a salient pole rotor. That means that the teeth formed between adjacent slots are wider in the area of the tooth crests—that is, in a radial direction outwards—than in the tooth neck area. The coils of the concentrated excitation winding are in the lower area of the rotor—that is, on the side facing the rotor axis. Above them—that is, in the radial direction, facing the stator—the coils of the concentrated field winding are located. The excitation winding is marked with reference symbols 3; the field winding, with reference symbol 6.

In the example under consideration, in accordance with FIG. 11, the fifth harmonic of the magnetomotive force is used as a work harmonic. Therefore, the rotor 2 is designed as a salient pole rotor with ten poles—that is, with ten teeth. The field winding of the rotor comprises coils which are wound around the individual teeth of the rotor in such a way that a suitable magnetic field of a ten-pole rotor is produced.

The fifth and the 13^{th} harmonics of the magnetomotive force in the air gap are shown in the middle of the image of FIG. 11; the force is produced by the stator winding. The fifth harmonic, which is used as the work harmonic, rotates at the rotor speed counterclockwise. The fifth harmonic is marked with reference symbol 9 and is depicted as a solid line. In contrast, another characteristic harmonic is present, in the machine shown, with 18 slots and ten poles and a concentrated winding, namely, the 13^{th} harmonic of the magnetomotive force in the air gap. The 13^{th} harmonic rotates clockwise at 5/13 of the rotor speed.

Therefore, one can see that the fifth and the 13^{th} harmonics spread with different orientations and have different speeds. The 13^{th} harmonic is depicted as a dotted line in the middle of the image of FIG. 11 and is marked with reference symbol 11.

The excitation winding of the rotor is supplied by the 13^{th} harmonic. The 13^{th} harmonic of the magnetomotive force produced by the stator winding is therefore used to supply the field winding of the rotor with energy.

FIG. 11 also shows that for the proposed self-excited synchronous machine, the stator winding and the rotor windings are simple concentrated windings which are wound around a tooth.

The two following tables show, by way of example, possible additional combinations of a number of stator slots Z and the number of the pole pairs p of the rotor in concentrated windings for self-excited synchronous machines in accordance with the proposed principle. As described above, one harmonic is used as the work harmonic and another harmonic, for the excitation of the rotor winding. Dependent on the combination of the number of stator slots and the number of rotor poles, the available harmonics for the excitation of the rotor field winding are indicated.

Table 1 shows the available harmonics for a two-layer winding.

TABLE 1

| | p | | | | | | | |
|---|---|---|---|---|---|---|---|---|
| Z | 1 | 2 | 4 | 5 | 7 | 8 | 10 | 11 |
| 3 | 2, 4, 5 | 1, 4, 5 | | | | | | |
| 6 | | 1, 4, 8 | 1, 2, 8 | | | | | |
| 9 | | 7, 11, | 5, 13, | | | | | |
| | | 16 | 14 | | | | | |
| 12 | | | | 7, 17, | 5, 17, | | | |
| | | | | 19 | 19 | | | |
| 18 | | | | 13, 23 | 11 | | | 7 |
| 24 | | | | | | | | 1, 13 |

Table 2, which follows, shows the available harmonics for a one-layer winding.

TABLE 2

| | p | | | | | | | |
|---|---|---|---|---|---|---|---|---|
| Z | 1 | 2 | 4 | 5 | 7 | 8 | 10 | 11 |
| 6 | | 1, 4, 8 | 1, 2, 8 | | | | | |
| 12 | | | | 1, 7, | 1, 5, | | | |
| | | | | 17 | 17 | | | |
| 24 | | | | | | | | 1, 13 |

Of course, it is up to the technical discretion of the expert to apply the principle proposed here to other embodiments of synchronous machines.

### LIST OF REFERENCE SYMBOLS

1 Stator
2 Rotor
3 Excitation winding
4 Rectifier
5 Capacity
6 Field winding
7 Current supply
8 Control unit
9 Fifth harmonic
10 Seventh harmonic
11 Thirteenth harmonic
ω_{R} Rotor speed
A, B, C Electric phases
E1 bis E5 Excitation winding
F Field winding
N North pole
S South pole
U1, U2 Terminals for field winding
X1 to X5 Terminals for excitation winding

1. Synchronous machine with a stator and a rotor situated so it can move relative to it;
the stator comprising at least one concentrated winding, which is located in slots of the stator;
the rotor comprising
a first winding system which is set up as an excitation winding;
at least one second winding system, which is set up as a field winding; and
a rectifier, which is connected between the first and the second concentrated winding systems;
wherein the first and the second winding systems comprise a concentrated winding.

2. Synchronous machine according to claim 1, wherein the at least one concentrated winding of the stator and/or the first winding system of the rotor are designed as multiphase, especially three-phase, concentrated windings.

3. Synchronous machine according to claim 1 or 2, wherein a higher harmonic of the electromotive force of the stator is used as the work harmonic.

4. Synchronous machine according to claim 3, wherein a harmonic of the electromotive force of the stator, different from the work harmonic, is used as the excitation harmonic to supply the excitation winding.

5. Synchronous machine according to claim 3, wherein the at least one concentrated winding of the stator produces both the work harmonic as well as the excitation harmonic.

6. Synchronous machine according to claim 1 or 2, wherein the field winding comprises several coils, which are wound around a tooth of the rotor and are connected in series with one another.

7. Synchronous machine according to claim 1 or 2, wherein the excitation winding and the field winding are wound around the same teeth of the rotor.

8. Synchronous machine according to claim 1 or 2, wherein the field winding and the excitation winding have different coil widths.

9. Synchronous machine according to claim 1 or 2, wherein the rotor is designed as a salient pole rotor.

10. Synchronous machine according to claim 1 or 2, wherein additional permanent magnets (S, N) are introduced into the rotor.

11. Synchronous machine according to claim 5, wherein 12 slots are provided in the stator and 10 poles, in the rotor, and wherein the 5^{th} harmonic is used as the work harmonic and the 7^{th} harmonic, as the excitation harmonic, or vice-versa.

12. Synchronous machine according to claim 1 or 2, wherein the stator is rectifier-free.

13. Synchronous machine according to claim 1 or 2, which is designed without brushes.
